(19) United States
(12) Patent Application Publication
(10) Pub. No.: US 2014/0363125 A1
(43) Pub. Date: Dec. 11, 2014

(54) CLADDING MODE STRIPPER

(71) Applicant: Prima Electro North America, LLC, Chicopee, MA (US)

(72) Inventors: Pieter Schwarzenbach, Longmeadow, MA (US); Matthew J. Silva Sa, Worcester, MA (US); Fabio Pozzi, Rivoli (Torino) (IT); Peter Reeves-Hall, Northbridge, MA (US)

(21) Appl. No.: 13/911,192

(22) Filed: Jun. 6, 2013

(51) Int. Cl. G02B 6/036

(52) U.S. Cl. CPC G02B 6/036
USPC 385/29

(57) ABSTRACT

An improved arrangement for stripping stray light energy that is propagating in the cladding layer of an optical fiber is provided. A cladding light stripper is provided that incorporates removal of at least a portion of the coating material and/or splicing the fiber to a fiber of differing diameter and/or having a bend of constant or decreasing or varying radius to efficiently remove cladding light while distributing heat dissipation in a controlled design across the device with respect to a specific direction of input (cladding) light.

### BACKGROUND OF THE INVENTION

The present invention relates generally to stripping stray light energy from optical fiber assemblies. More specifically, the present invention relates to stripping stray light energy that is propagating in the cladding layer of an optical fiber.

Advances in laser technology have allowed for the development of increasingly high powered systems. Such high powered systems include free space lasers, as well as lasers confined to waveguides, such as fiber lasers. Fiber lasers have significant advantages over traditional lasers, including stability of alignment, scalability and high optical power of a nearly diffraction limited output beam.

In a fiber laser, the gain medium is a length of an optical fiber, the core of which is doped with an active lasing material, typically ions of a rare earth element, such as erbium or ytterbium or both. The lasing material is usually pumped using an emission of a diode laser or an array of diode lasers. The advent of double clad active optical fibers, having inner and outer claddings in which the pump light is coupled to the inner cladding to be absorbed at the doped fiber core along the fiber length, allowed a considerable increase in overall output power of a fiber laser, while preserving the brightness and directivity of a single mode output laser beam. Power levels of the order of several kilowatts or even tens of kilowatts in an almost single mode output laser beam are now achievable, opening a great variety of industrial applications, such as concrete drilling or sheet metal cutting for the car industry or shipbuilding.

At the high optical power levels of fiber lasers, the task of managing stray light becomes crucial. A doped fused silica core and a fused silica inner cladding or claddings of the fiber lasers are surrounded by an external coating made of a polymer. Having an external polymer coating is essential because without it, the optical fiber becomes very brittle. At high pump power levels, even a small fraction of stray light can heat the polymer coating to a temperature at which it can be damaged, causing catastrophic failure of the active fiber of the laser. For instance, in fiber laser arrangements where the fiber is pumped at one end and a catastrophic thermal failure occurs at the other end, the fiber can actually start burning towards the pump end, causing the entire length of fiber to be destroyed.

In fiber lasers, the stray light and associated heating is caused by so called cladding modes, that is, modes of light propagating in the cladding. In double clad fibers, the cladding modes of the inner cladding are used to deliver the pump light to the fiber core. When the light of the cladding modes escapes the inner cladding, it can cause a localized heating of the fiber polymer coating, resulting in a catastrophic failure of the active fiber. Because of this, the cladding modes need to be removed (stripped) from the fiber where they are no longer required, or where they should not be normally present, such as in outer cladding of a double clad fiber. For example, when an active optical fiber is pumped at one end, the residual inner cladding light can be removed at the other end of the fiber to prevent its further propagation. Furthermore, the cladding modes present in the outermost cladding can be removed at the pump end of the active fiber. The cladding light can include the residual (unabsorbed) pump light, amplified spontaneous emission (ASE) of the active fiber core and the laser light at the wavelength of lasing that escaped the fiber core.

Cladding modes are typically removed using cladding mode stripper devices, or cladding mode strippers. A cladding mode stripper of the prior art has a layer of a high-index material disposed next to and optically coupled to the cladding of the optical fiber. The cladding light present in the cladding is coupled to the high-index material and is absorbed in the high-index material or in an opaque solid shield disposed around the high-index material. An index-matching gel or a coating of a high-index polymer is typically used in a cladding mode stripper.

To facilitate a more uniform distribution of cladding mode light stripped along a length of an optical fiber, the prior art had provided varying the refractive index of the high-index polymer along the fiber length. Further, in other cladding mode stripper devices, the sheath (the outer coating) is gradually thinned along the fiber so that the cladding modes can escape gradually, thus lowering the peak temperatures. Other prior art devices disclose a cladding mode stripper, in which a light-scattering material is deposited on the fiber to scatter the cladding mode light. Generally the difficulty is that the prior-art approaches are not scalable to very high optical power levels, being specific to particular fiber types and particular optical power ranges.

There is therefore a need for a cladding mode stripper that removes stray cladding modes from a high powered fiber assembly in a distributed manner. There is a further need for a cladding mode stripper that removes cladding modes from a fiber in a distributed manner to reduce heating and allow removal of significant cladding light without damage to the fiber or the cladding mode stripper device.

### BRIEF SUMMARY OF THE INVENTION

In this regard, the present invention provides for an improved arrangement for stripping stray light energy that is propagating in the cladding layer of an optical fiber. As such, the general purpose of the present invention, which will be described subsequently in greater detail, is to provide an improved cladding mode stripper that operates at a much higher efficiency as compared to the prior art in order to reduce operating temperatures at splices and complex optical devices downstream.

Within the scope of the present invention, it should be appreciated by one skilled in the art that the term fiber or active fiber is meant to be inclusive or any known arrangement. Such arrangements include, but are not limited to, standard clad fibers, double clad fibers, fiber bundles, multi-core fibers, solid or photonic crystal clad fibers, non-circular fibers and polarization maintaining fibers.

It is known that the greater the localized absorption of the cladding light the greater the localized heating of the fiber assembly. If the localized heating is too great, then there may occur gradual degradation or catastrophic damage to the fiber coating (acrylate/silicon/polyamide or other coating) and/or the epoxy/silicon/potting compound/coolant liquid/holder material that is near or in contact to the heat zone location. Accordingly, the present invention provides a cladding mode light stripping device, or series of devices that have purposeful design to distribute the light extraction and/or localized heating to allow removal of many watts (>100 W) of cladding light without device damage and/or with long device lifetime.

It is an object of the present invention to provide a cladding light stripper that incorporates removal of at least a portion of the coating material and/or splicing the fiber to a fiber of differing diameter and/or having a bend of constant or decreasing or varying radius to efficiently remove cladding light while distributing heat dissipation in a controlled design across the device with respect to a specific direction of input (cladding) light.

In one embodiment, a cladding light removal device is provided consisting of full/partial/graduated removal of coating material followed by bend(s) in the fiber in one or multiple planes.

In another embodiment, a cladding light removal device is provided consisting of graduated coating material removal and bend(s) of decreasing radius of curvature, spiral and/or alternating S-bends of decreasing radius of curvature.

In another embodiment, a cladding light removal device is provided consisting of a fiber with complete or graduated outer coating material removal, followed by a fiber splice to a smaller diameter fiber with complete outer coating material removal followed by bend(s) of similar/constant or decreasing radius of curvature, spiral and/or alternating (S) bends, of decreasing radius of curvature.

In a further embodiment, a cladding light removal device is provided consisting of partial removal of coating material, followed by bend(s) of constant or decreasing radius of curvature, spiral and/or alternating S-bends of decreasing radius of curvature, followed by graduated and/or full removal of coating material.

In still a further embodiment, a cladding light removal device is provided consisting of partial removal of coating material, followed by bend(s) of constant or decreasing radius of curvature (spiral and/or alternating (S) bends of decreasing radius of curvature, followed by graduated and/or full removal of coating material followed by further bends of constant or decreasing radius of curvature, spiral and/or alternating S-bends of decreasing radius of curvature.

Another embodiment provides any of the devices above designed for removal of cladding light travelling in both directions with respect to the direction of the majority of core light.

Still another embodiment provides for the use of low loss material of specific refractive index, e.g. Quartz glass or a secondary layer(s) of potting material of specific refractive index(s), to guide stripped cladding light away from the fiber to a physical location that light dissipation/absorption heating is thermally advantageous compared to the local vicinity of the fiber.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a cross-sectional representation of an optical fiber;

FIG. 2 is a plan view of a cladding mode stripper in accordance with one embodiment of the invention;

FIG. 3 is a plan view of a cladding mode stripper in accordance with an alternate embodiment of the invention;

FIG. 4 is a plan view of a cladding mode stripper in accordance with another alternate embodiment of the invention;

FIG. 5 is a plan view of a cladding mode stripper in accordance with yet another embodiment of the invention;

FIG. 6 is a plan view of a cladding mode stripper in accordance with still another embodiment of the invention;

FIG. 7 is a plan view of a cladding mode stripper in accordance with an embodiment of the invention for stripping cladding light travelling in both directions along the fiber;

FIG. 8 is a cross-sectional view of a wave guide for directing stripped light away from a fiber; and

FIG. 9 is a plan view of a cladding mode stripper in accordance with another alternate embodiment of the invention.

### DETAILED DESCRIPTION OF THE INVENTION

Now referring to the drawings, the system for removing cladding mode light from a fiber laser is shown and generally illustrated in the figures. As can be seen, the present invention provides an improved cladding mode stripper that operates at a much higher efficiency as compared to the prior art in order to reduce operating temperatures at splices and complex optical devices downstream.

As stated above, in high power fiber optic systems, such as may include fiber amplifiers, fiber lasers, and fiber coupled diode lasers, a significant amount of light may be guided in the cladding of the optical fiber for the purpose of excitation and amplification. However, a significant amount of the cladding light can remain in the cladding as the signal is passed into a transmission fiber so as to interfere with the output from the core. In certain circumstances, the cladding light can also be of a sufficient power level to heat the cladding, which can decrease performance and/or cause damage to the optical fiber. Further, the output quality of the fiber light source might be essential for material processing applications like marking, cutting, welding, sintering, etc. If the output source contains light in the cladding and/or the coating its focal spot size will be larger than another similar fiber light source which has not cladding and/or coating light.

As used herein, the term “high power” refers to at least one or more hundred watts and for many applications may mean one or more kilowatts. By way of example, lasers with high output powers are required for a number of applications, e.g., for material processing (welding, cutting, drilling, marking, surface modification), large-scale laser displays, military applications, particle acceleration, and laser-induced nuclear fusion. It will be understood that the present invention is not limited to lasers as it may be applied to other high power optical applications, such as fiber amplifiers and fiber coupled laser diodes.

Further, within the scope of the present invention, it should be appreciated by one skilled in the art that the term fiber or active fiber is meant to be inclusive or any known arrangement. Such arrangements include, but are not limited to, standard clad fibers, double clad fibers, fiber bundles, multi-core fibers, solid or photonic crystal clad fibers, non-circular fibers and polarization maintaining fibers.

Turning to FIG. 1. It can be seen that in fiber light sources (lasers and amplifiers) the optical fiber typically consist of 3 regions; 1) a central core glass, 2) a surround cladding glass, 3) a 2^{nd} cladding or “coating” (typically polymer or low index glass). It is usually required that the light be constrained to the core 1 to provide the best beam quality when focused and to reduce heating or damage of any optical components that are attached (via bulk optics or fiber splicing) that are designed to receive only core light from the fiber light source.

As stated above however, during the laser excitation and amplification process it may be unavoidable to have significant quantities of light present in the cladding glass and/or the coating. For all of the reasons stated above it is advantageous to remove any cladding and coating light. The greater the light removal from the cladding and/or coating the greater the stripping efficiency of such a device. It is advantageous to maximize this efficiency. Preferably a light removal on the order of 95% is desirable to reduce temperatures at splice locations downstream of the cladding mode stripper and a light removal of greater than 99% is desirable to reduce temperatures at complex optical devices downstream such as output combiners and delivery fiber couplers.

As such, the materials surrounding and employed for potting of the stripped fiber are carefully selected for their thermal and/or light guiding properties. Epoxies, silicones and other potting materials may be selected with a specific optical refractive index. Due to total internal reflection light with a certain numerical aperture (N.A.) will be guided in a higher refractive index region of the cladding. If the outer coating material is removed and the stripped fiber potted into a high index material, the light will not be guided in the cladding anymore. To achieve this extraction, the fiber is coated with epoxies or other materials and/or prepared in such a way to permit extraction of significant quantities of cladding light in a manner that transfers the stripped light and heat away from the interaction region to prevent damage from localized heating and light intensity.

The greater the localized removal light the greater the localized heating. If the localized heating is too great then there may occur gradual degradation or catastrophic damage to the fiber coating (acrylate/silicon/polyamide or other coating) and/or the epoxy/silicon/potting compound/coolant liquid/holder material that is near or in contact to the heat zone location.

It can be further considered that the device has a specific orientation as there may be significant cladding light requiring removal from an optical fiber source to the “input” the device (with respect to direction of travel of the majority of the core light). There may also be cladding light of a similar or different intensity and/or wavelength into the “output” of the device from a fiber source/reflection “downstream” of the device that also requires removal.

Taking these factors into consideration, the stripping of cladding mode light is preferably achieved by processing the fiber to remove the coating and potting the exposed section(s) of fiber core in a potting material of the same or greater refractive index as that of the cladding. Further, cladding light is removed more efficiently proportionally to the reduction in the cross sectional area of cladding material per unit length. This makes the removal of cladding light at locations where there is a decrease in the cladding diameter, such as a splice between a larger diameter fiber and a small diameter fiber, or when there is a fiber taper more efficient. Further the longer the length of stripped coating removed the greater the amount of cladding light removal and the bending of the fiber creating a decrease in the critical reflectivity angle on the cladding at the outside of the bend allows low N.A. cladding light to be more easily removed. It also follows then that cladding light is removed more efficiently when the bend radius of the stripped section of fiber is reduced.

In using one or a combination of the above techniques, the stripped cladding light is then preferably directed away from the fiber via a low loss (wave guiding) media to be absorbed at a preferred physical location for thermal management, e.g. with the use of a Quartz glass slide on top of the stripped fiber.

It should be appreciated by one skilled in the art that the above rules may be mixed to design a cladding mode light stripping device, or series of devices that have purposeful design to distribute the light extraction and/or localized heating to allow removal of many watts (>100 W) of cladding light without device damage and/or with long device lifetime (MTF).

In most general terms the present invention therefore provides a system for removing cladding mode light comprising an optical fiber having an elongated core surrounded by a cladding, the cladding having a lower refractive index relative to the core, wherein cladding mode light propagates within said cladding. At least portion of the coating being removed along a predetermined length thereof and the fiber being bent at that location. This bend in the fiber coupled with the reduction in thickness or removal of the coating causes the critical angle of the light path relative to the outer surface of the cladding layer to become smaller in a manner that reduces the total internal reflection and the cladding mode light escapes the fiber structure. Within this design, the removal of the coating may be a full, partial or graduated removal of the material coupled with a bend that has a radius of curvature that is constant, decreasing or varied over the length of the bend.

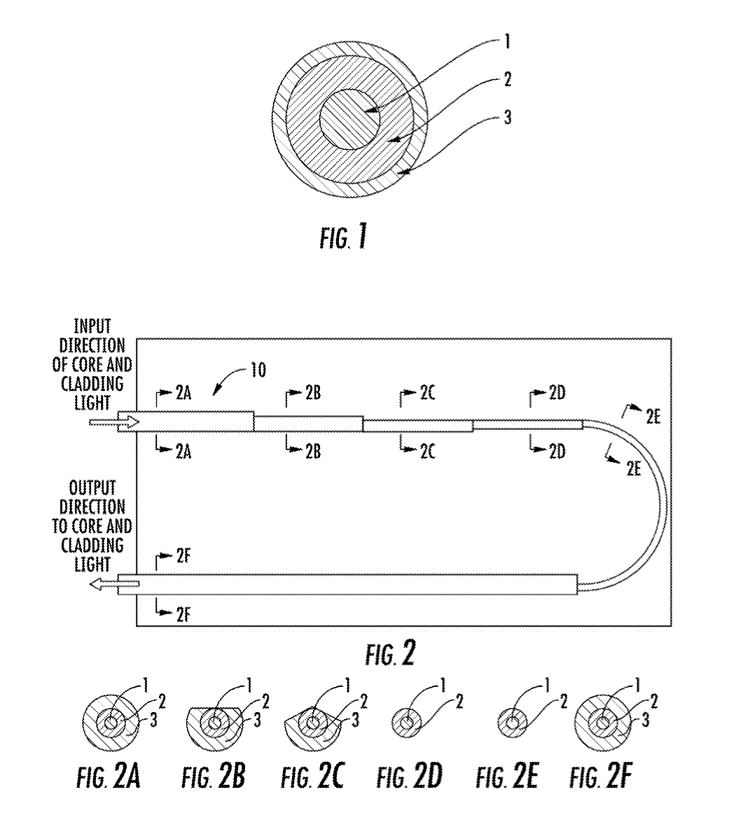

As can be seen in FIG. 2, an input fiber 10 is shown carrying core light and cladding light. In accordance with the present invention the coating 3 is removed in a stepwise, graduated fashion along the length for the fiber 10. The core 1 material, minus any coating 3 material is bent and the core 1 is then directed back into a fully clad fiber section. In this manner, cladding mode light is allowed to escape from the fiber at the bend as the critical angle for total internal reflection is reduced causing the cladding mode light to exit the surface of the cladding rather than being reflected and propagated. It should be appreciated by one skilled in the art that while a graduated removal of the coating is shown in the figure, such coating removal may be full, partial of graduated. Further, the bend shown may be in a single plane or in more than one plane.

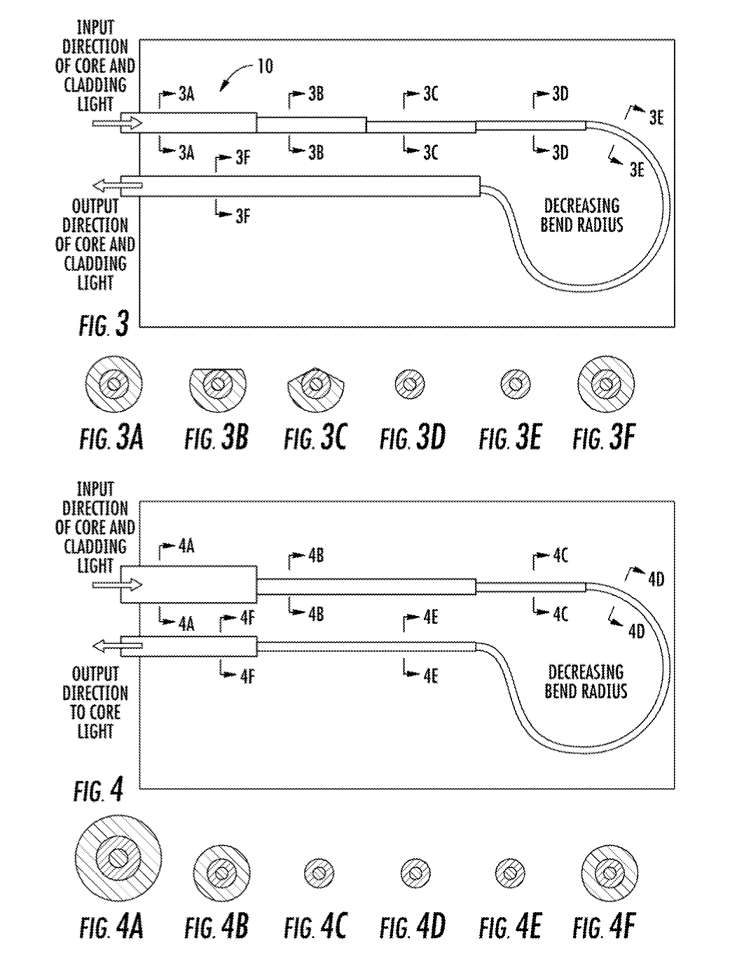

At FIG. 3, an input fiber 10 is shown carrying core light and cladding light. As stated above in FIG. 2, the coating is removed in a stepwise, graduated fashion along the length for the fiber. The core material, minus any coating material is bent along a decreasing radius of curvature and the core is then directed back into a fully clad and coated fiber section. In this manner, cladding mode light across a range of wavelengths is allowed to escape from the fiber at the bend as the critical angle for total internal reflection is progressively reduced along the length of the decreasing radius curve causing the cladding mode light to exit the surface of the cladding rather than being reflected and propagated. Again, one skilled in the art should appreciate that while a graduated removal of the coating is shown in the figure, such coating removal may be full, partial of graduated. Further, the bend shown may be in a single plane or in more than one plane.

In an alternate embodiment shown at FIG. 4, the coating is removed from a fiber having a first diameter. The exposed core/cladding is then spliced into a fiber having a second diameter, preferably smaller than the first diameter fiber. The smaller diameter fiber, minus any coating material is then bent along a curve having either a constant or decreasing radius of curvature and the core is then directed back into a fully clad and coated fiber section. In this manner, cladding mode light across a range of wavelengths is allowed to escape from the fiber at the bend as the critical angle for total internal reflection is progressively reduced along the length of the decreasing radius curve causing the cladding mode light to exit the surface of the cladding rather than being reflected and propagated.

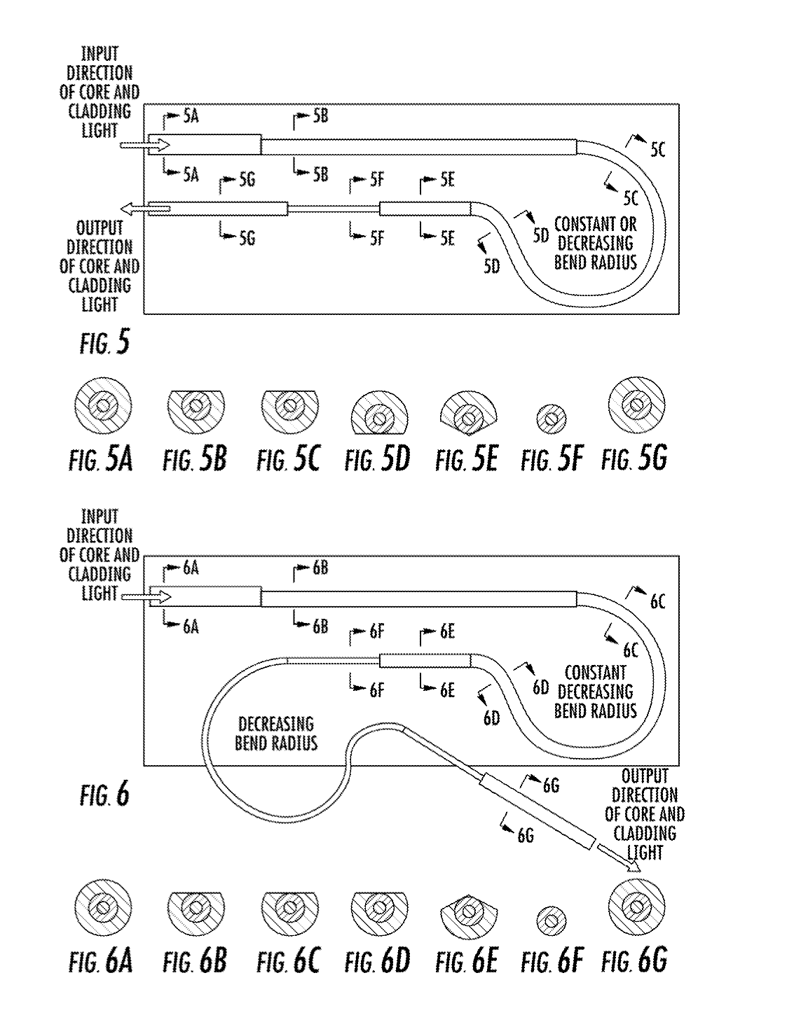

In a further alternate embodiment, FIG. 5 provides for a partial removal of the coating material. The partially coated fiber is then bent along a curve having a constant or decreasing radius of curvature. After the curve, the coating may be removed fully or in a graduated fashion and the core is then directed back into a fully clad fiber section. In this manner, cladding mode light across a range of wavelengths is allowed to escape from the fiber at the bend as the critical angle for total internal reflection is progressively reduced along the length of the decreasing radius curve causing the cladding mode light to exit the surface of the cladding rather than being reflected and propagated.

FIG. 6 depicts an alternate embodiment that first provides for a partial removal of the coating material. The partially coated fiber is then bent along a curve having a constant or decreasing radius of curvature. After the curve, the coating may be removed fully or in a graduated fashion. The fiber, stripped of its coating is then subjected to a second bend and the core is then directed back into a fully clad and coated fiber section.

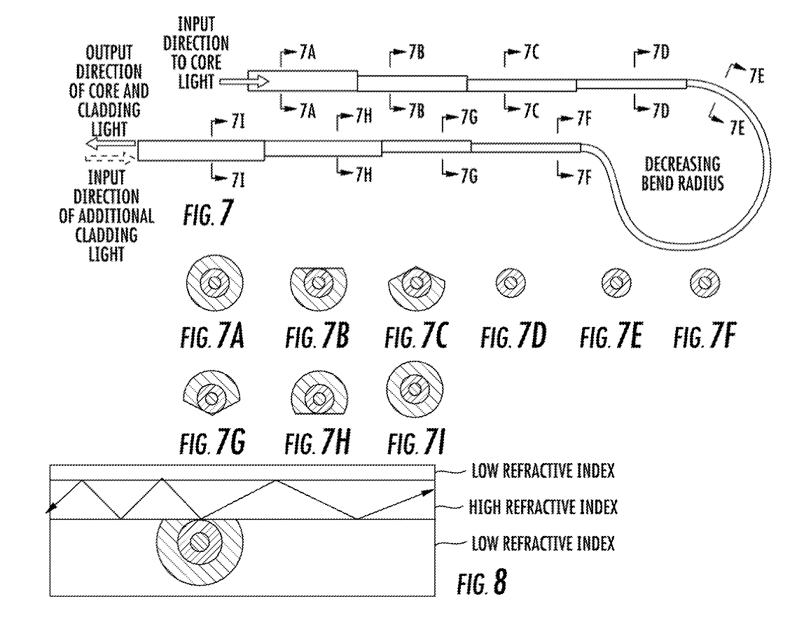

FIG. 7 provides for an alternate embodiment wherein the fiber is carrying cladding light that is travelling in both directions relative to the core light. In this case an input fiber is shown carrying core light and cladding light potentially traveling in either direction. In accordance with the present invention the coating is removed in a stepwise, graduated fashion along both ends of the fiber as they approach a location where the clad core material, minus any coating material is bent into a curve. In this manner, cladding mode light travelling in either direction is allowed to escape from the fiber at the bend as the critical angle for total internal reflection is reduced causing the cladding mode light to exit the surface of the cladding rather than being reflected and propagated.

It should be appreciated by one skilled in the art that while each of the embodiments shows a particular associated removal of coating, in any of the embodiments the removal of the coating may be full, partial of graduated. Further, the bend shown in any embodiment may have constant curvature, a decreasing radius of curvature or a spiral curve, the curved fiber may be in a single plane or in more than one horizontal plane and there may be any number of sequential curves, one following the other.

Turning to FIG. 8 a stripper arrangement is shown that may be employed with any of the above embodiments as a means to strip cladding mode light away from the fiber to a location where light and heat dissipation is acceptable. In this manner a low loss material such as a quartz glass or secondary layer of potting material having a relatively high refractive index is placed in proximity with the cladding layer wherein a full of partial stripping of the coating has been completed. In this case proximity meaning anywhere from direct contact with the cladding to as much as the a spacing equal to the width of the fiber. This further allows an increase in the area of absorption and a redistribution of the dissipation to reduce the maximum temperature of the system.

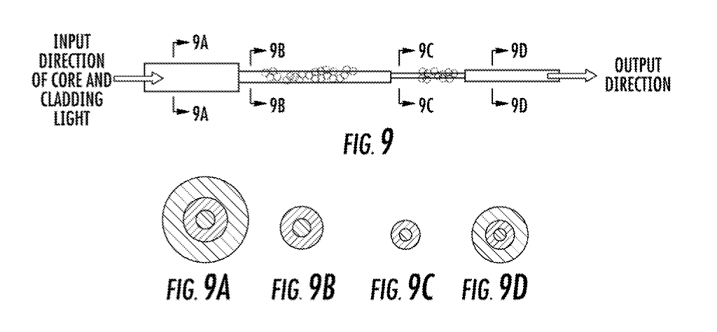

At FIG. 9 another embodiment is shown wherein the fiber is processed to remove the coating material. Further, some or all of the exposed cladding glass is then processed to generate surface irregularities that disrupt the total internal reflection of the cladding and promote refraction of the light within the cladding sending it in random directions. Processes for inducing surface irregularities include abrasion/ablation to form scratches, pits, cuts, holes, acid treatment to create frosting, pitting and/or crystalline deposits, heat treating for glass shaping. The amplitude or density of the surface irregularities may vary by either increasing and/or decreasing along the path of the light. Once the surface irregularities are formed, optionally optical structures may be attached to the cladding or the exposed irregular glass is potted in a material of lower refractive index than the cladding glass (e.g. low refractive index silicone) such that the glass cladding surface irregularities cause refraction of light out of the cladding glass and into the low index material surrounding the cladding. This embodiment may be used in connection with change in fiber type/diameter but does not require the introduction of curved fiber sections to achieve high efficiency removal of cladding light.

It can therefore be seen that the present invention provides an improved arrangement for stripping stray light energy that is propagating in the cladding layer that operates at a much higher efficiency as compared to the prior art in order to reduce operating temperatures at splices and complex optical devices downstream. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A system for removing cladding mode light comprising:
an optical fiber having at least an elongated core surrounded by one or more cladding layers, the cladding having a lower refractive index relative to the core and a coating layer having a lower refractive index relative to the cladding, wherein cladding mode light propagates within said cladding;
said optical fiber having at least portion of said coating removed along a predetermined length thereof; and
said optical fiber being bent along said predetermined length.

2. The system of claim 1, wherein said coating is partially removed from said cladding along said predetermined length.

3. The system of claim 1, wherein said coating is fully removed from said cladding along said predetermined length.

4. The system of claim 1, wherein said coating removal from said cladding is graduated along said predetermined length.

5. The system of claim 1, wherein said optical fiber is bent into a curve having a decreasing radius of curvature.

6. The system of claim 1, wherein said optical fiber is bent into a spiral.

7. The system of claim 1, wherein said optical fiber is bent into at least two alternating curves.

8. The system of claim 1, wherein said bend is oriented in more than one plane.

9. The system of claim 1, further comprising:
a high index guide in proximity with said cladding along said predetermined length to guide cladding mode light away from said optical fiber.

10. A system for removing cladding mode light comprising:
an optical fiber having at least an elongated core surrounded by one or more cladding layers, the cladding having a lower refractive index relative to the core and a coating layer having a lower refractive index relative to the cladding, wherein cladding mode light propagates within said cladding;
said optical fiber having at least portion of said coating removed along a predetermined length thereof, said optical fiber being bent along said predetermined length; and
a high index guide in proximity with said cladding along said predetermined length to guide cladding mode light away from said optical fiber.

11. A system for removing cladding mode light comprising:
a first optical fiber having at least an elongated core surrounded by one or more cladding layers, the cladding having a lower refractive index relative to the core and a coating layer having a lower refractive index relative to the cladding, wherein cladding mode light propagates within said cladding;
said first optical fiber having at least portion of said coating removed along a predetermined length thereof;
said first optical fiber spliced to a second optical fiber having a smaller diameter than said first optical fiber; and
said second optical fiber being bent.

12. The system of claim 11, wherein said coating is fully removed from said second fiber.

13. The system of claim 11, wherein said second optical fiber is bent into a curve having a decreasing radius of curvature.

14. The system of claim 11, wherein said second optical fiber is bent into a spiral.

15. The system of claim 11, wherein said second optical fiber is bent into at least two alternating curves.

16. The system of claim 11, wherein said bend is oriented in more than one plane.

17. The system of claim 11, further comprising:
a high index guide in proximity with said second fiber to guide cladding mode light away from said optical fiber.

18. A system for removing cladding mode light comprising:
an optical fiber having at least an elongated core surrounded by one or more cladding layers, the cladding having a lower refractive index relative to the core and a coating layer having a lower refractive index relative to the cladding, wherein cladding mode light propagates within said cladding;
said optical fiber having at least portion of said coating removed along a predetermined length thereof; and
a portion of an outer surface of said cladding having surface irregularities formed therein.

19. The system of claim 18, further comprising:
a low index guide in proximity with said cladding having surface irregularities to guide cladding mode light away from said optical fiber.
